(19) United States
(12) Patent Application Publication
(10) Pub. No.: US 2021/0107176 A1
(43) Pub. Date: Apr. 15, 2021

(54) SHEET MANUFACTURING APPARATUS

(71) Applicant: SEIKO EPSON CORPORATION, Tokyo (JP)

(72) Inventors: Masanao FUKASAWA, Matsumoto, Nagano (JP); Naotaka HIGUCHI, Suwa-gun, Fujimi-machi, Nagano (JP); Makoto YOSHIDA, Matsumoto, Nagano (JP)

(21) Appl. No.: 16/464,344

(22) PCT Filed: Nov. 7, 2017
(86) PCT No.: PCT/JP2017/040074

§ 371 Date: May 28, 2019

(30) Foreign Application Priority Data
Nov. 29, 2016 (JP) 2016-231151

(51) Int. Cl. B27N 3/04; D04H 1/732; B27N 3/16

(52) U.S. Cl. CPC B27N 3/04; B27N 3/16; D04H 1/732

(57) ABSTRACT

A web forming section that deposits a mixture including a defibrated object and a resin on a mesh body and that forms a web; a transport section that transports the web from the mesh body; and an eliminating section that eliminates, by using an airflow, the mixture remaining on the mesh body after the web is transported by the transport section are provided. The eliminating section generates the airflow.

### CROSS-REFERENCE TO RELATED APPLICATIONS

This application is a U.S. National stage application of International Patent Application No. PCT/JP2017/040074, filed on Nov. 7, 2017, which claims priority under 35 U.S.C. § 119(a) to Japanese Patent Application No. 2016-231151, filed in Japan on Nov. 29, 2016. The entire disclosure of Japanese Patent Application No. 2016-231151 is hereby incorporated herein by reference.

### TECHNICAL FIELD

The present invention relates to a sheet manufacturing apparatus.

### BACKGROUND ART

Hitherto, a sheet is manufactured by depositing a fiber-like substance and causing cohesion to act between the deposited fibers.

In this case, for example, a sheet manufacturing apparatus that forms a web by depositing, on a mesh belt, a mixture (a defibrated object and an additive) which passed through an opening of a deposition section, and forms a sheet by pressing and heating the web (for example, see Japanese Unexamined Patent Application Publication No. 2016-175403).

However, with the related art, when the mixture remains on the mesh belt, the mesh belt may be skewed or deformed, and the durability of the mesh belt and quality of a sheet may be decreased.

### SUMMARY

To address the problem, an object of the invention is to keep the surface state of a mesh belt uniform, to suppress a decrease in the durability of the belt, and to make the quality of a sheet stable.

To attain the object, a sheet manufacturing apparatus according to the invention includes a web forming section that deposits a mixture including a defibrated object and a resin on a mesh body and that forms a web; a transport section that transports the web from the mesh body; and an eliminating section that eliminates, by using an airflow, the mixture remaining on the mesh body after the web is transported by the transport section. The eliminating section generates the airflow.

With the invention, the eliminating section can eliminate the mixture remaining on the mesh body by using the airflow. Consequently, the surface state of the mesh body can be kept uniform and the durability of the mesh body can be increased. In addition, since the remaining mixture is not present on a deposition surface side of the mesh body, the mixture can fall on the surface of the mesh body and the web can be uniformly formed. Thus, the quality of a sheet can be stable.

Also, in the invention, the airflow generated from the eliminating section is an airflow directed from a back surface side of a deposition surface of the mesh body on which the mixture is deposited toward a deposition surface side of the mesh body.

With the invention, since the eliminating section sends the airflow directed from the back surface side of the mesh body toward the deposition surface side of the mesh body, the mixture remaining on the deposition surface side of the mesh body can be eliminated.

Also, in the invention, the eliminating section includes an air sending portion that blows an airflow on the mesh body from the back surface side of the mesh body.

With the invention, since the air sending portion of the eliminating section sends the airflow toward the back surface side of the mesh body, the mixture remaining on the deposition surface side of the mesh body can be eliminated.

Also, in the invention, the eliminating section includes an air sending chamber located on the back surface side of the mesh body and having an outlet port through which an airflow from the air sending portion is output; and a first seal member that provides sealing between a periphery of the outlet port of the air sending chamber and the mesh body.

With the invention, since the first seal member provides the sealing between the periphery of the outlet port of the air sending chamber and the mesh body, a change in the humidity environment in the vicinity of the eliminating section can be suppressed.

Also, in the invention, the eliminating section includes a suction portion that sucks air from the deposition surface side of the mesh body.

With the invention, since the eliminating section sucks the air from the deposition surface side of the eliminating section, the mixture remaining on the deposition surface side of the mesh body can be eliminated.

Also, in the invention, the eliminating section includes a suction chamber located on the deposition surface side of the mesh body, communicating with the suction portion, and having a suction opening; and a second seal member that provides sealing between a periphery of the suction opening of the suction chamber and the mesh body.

With the invention, since the second seal member provides the sealing between the periphery of the suction opening of the suction chamber and the mesh body, a change in the humidity environment in the vicinity of the eliminating section can be prevented.

Also, in the invention, the eliminating section includes an air sending chamber located on the back surface side of the mesh body and having an outlet port through which an airflow is output to the mesh body; a suction chamber located on the deposition surface side of the mesh body and having a suction opening which faces the outlet port and through which air from the outlet port is sucked; a guide portion that is located on the back surface side of the mesh body and that guides the mesh body; and a seal member that is located between the suction chamber and the mesh body, that presses the mesh body against the guide portion, and that provides sealing between a periphery of the suction opening and the mesh body and between a periphery of the outlet port and the mesh body.

With the invention, the seal member provided between the suction chamber and the mesh body has a function of the sealing between the periphery of the outlet port of the air sending chamber and the mesh body, and between the periphery of the suction opening of the suction chamber and the mesh body. Thus, the structure can be simplified.

Also, in the invention, the suction chamber has at least one wall portion provided in a direction intersecting with a flow direction of an airflow.

With the invention, since the wall portion is provided, an airflow flowing in the suction chamber can be uniform.

Also, in the invention, humidified air is supplied to the eliminating section and the eliminating section eliminates the mixture by using the humidified air.

With the invention, since the humidified air is used, electrical charge due to dryness of the mesh body can be suppressed.

### BRIEF DESCRIPTION OF DRAWINGS

FIG. 1 is a schematic view illustrating a configuration and an operation of a sheet manufacturing apparatus to which the invention is applied.

FIG. 2 is a configuration diagram of a deposition section and a transport section.

FIG. 3 is a plan view of an eliminating unit.

FIG. 4 is a cross-sectional view of the eliminating unit.

FIG. 5 is an enlarged view of the eliminating unit.

FIG. 6 is a cross-sectional view illustrating another example of sealing.

FIG. 7 is a cross-sectional view illustrating still another example of sealing.

FIG. 8 is a cross-sectional view illustrating another example of the eliminating unit.

FIG. 9 is a cross-sectional view illustrating a modification of the eliminating unit.

FIG. 10A is an explanatory view illustrating a case where an airflow flows from a deposition surface side.

FIG. 10B is an explanatory view illustrating another case where an airflow flows from a deposition surface side.

FIG. 11 is an explanatory view illustrating still another case where an airflow flows from a deposition surface side.

### DESCRIPTION OF EMBODIMENTS

Embodiments of the invention are described below with reference to the drawings.

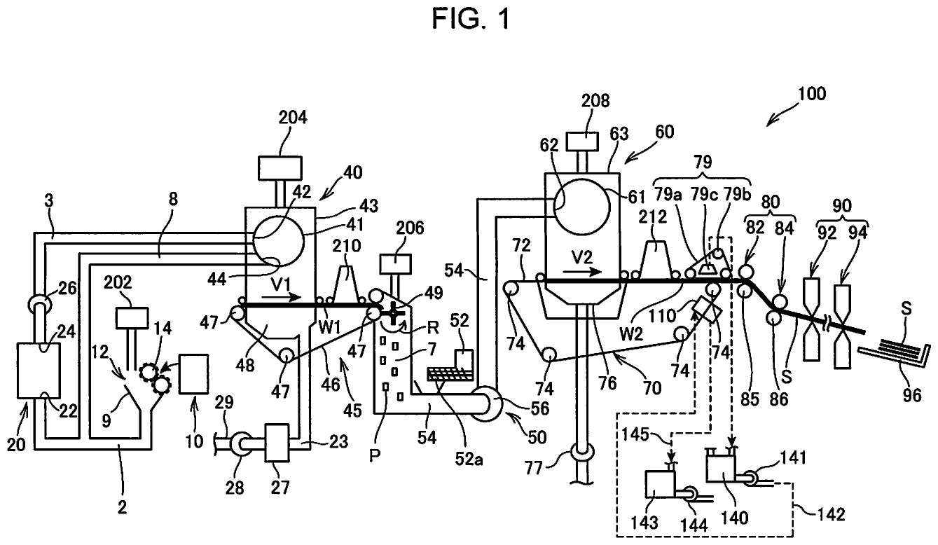

FIG. 1 is a schematic view illustrating a configuration and an operation of an embodiment of a sheet manufacturing apparatus of the invention.

A sheet manufacturing apparatus 100 described in this embodiment is, for example, an apparatus suitable for manufacturing new paper by defibrating used paper such as confidential paper serving as a raw material into fibers in a dry process, then applying heat and pressure to the fibers, and cutting the fibers. By mixing various additives into the fiber raw material, the bonding strength and the degree of whiteness of paper products may be increased and functions, such as color, fragrance, and flame retardancy, may be added in accordance with the purpose of use. In addition, by forming paper while the density, thickness, and shape of paper are controlled, paper with various thicknesses and sizes can be manufactured in accordance with the purpose of use, such as office paper of A4 or A3 or paper for business cards.

As illustrated in FIG. 1, the sheet manufacturing apparatus 100 includes a supply section 10, a rough crush section 12, a defibrator 20, a sorting section 40, a first web forming section 45, a rotary body 49, a mixing section 50, a deposition section 60, a second web forming section 70, a transport section 79, a sheet forming section 80, and a cutting section 90.

In addition, the sheet manufacturing apparatus 100 includes humidifying units 202, 204, 206, 208, 210, and 212 for humidifying a raw material and/or humidifying a space in which the raw material moves. Specific configurations of the humidifying units 202, 204, 206, 208, 210, and 212 may be desirably determined and may be, for example, steam type, vaporizing type, warm-air vaporizing type, or ultrasonic type.

In this embodiment, the humidifying units 202, 204, 206, and 208 are constituted of humidifiers of vaporizing type or warm-air vaporizing type. That is, the humidifying units 202, 204, 206, and 208 each have a filter (not illustrated) that is infiltrated with water and transmits air to supply humidifying air having an increased humidity.

In addition, in this embodiment, the humidifying units 210 and 212 are constituted of ultrasonic type humidifiers. That is, the humidifying units 210 and 212 each have a vibrating portion (not illustrated) that atomizes water and that supplies a mist generated by the vibrating portion.

The supply section 10 supplies a raw material to the rough crush section 12. The raw material with which the sheet manufacturing apparatus 100 manufactures a sheet may be any material as long as the material includes fibers. For example, the raw material may be paper, pulp, a pulp sheet, fabric including nonwoven fabric, or woven fabric. In this embodiment, for example, the sheet manufacturing apparatus 100 uses used paper as a raw material.

The rough crush section 12 shreds (roughly crushes) the raw material supplied by the supply section 10, by using a rough crush blade 14, into roughly crushed pieces. The rough crush blade 14 shreds the raw material in a gas such as an atmosphere (air). The rough crush section 12 includes, for example, a pair of rough crush blades 14 that pinch and shred the raw material, and a driving portion that rotates the rough crush blades 14. The rough crush section 12 may have a configuration similar to what-is-called shredder. The shapes and sizes of the rough crush pieces are desirably determined as long as being suitable for defibrating processing by the defibrator 20. For example, the rough crush section 12 shreds the raw material into paper pieces with sizes one to several centimeters square or smaller.

The rough crush section 12 has a chute (a hopper) 9 that receives the roughly crushed pieces shredded by the rough crush blades 14 and fell. The chute 9 has, for example, a tapered shape having a width that gradually decreases in a direction in which the roughly crushed pieces flow (an advance direction). Thus, the chute 9 can receive many roughly crushed pieces. The chute 9 is coupled to a pipe 2 that communicates with the defibrator 20. The pipe 2 defines a transport path for transporting the raw material (the roughly crushed pieces) shredded by the rough crush blades 14 to the defibrator 20. The roughly crushed pieces are collected by the chute 9 and transferred (transported) through the pipe 2 to the defibrator 20.

The humidifying unit 202 supplies humidifying air to the chute 9 of the rough crush section 12 or to the vicinity of the chute 9. Thus, a phenomenon in which a roughly crushed object shredded by the rough crush blades 14 is attracted to the inner surface of the chute 9 or the pipe 2 due to static electricity can be suppressed. In addition, since the roughly crushed object shredded by the rough crush blades 14 is transferred to the defibrator 20 together with the air which was humidified (with high humidity), an advantageous effect of suppressing adhesion of a defibrated object to the inside of the defibrator 20 is expected. Moreover, the humidifying unit 202 may supply the humidifying air to the rough crush blades 14 to eliminate static electricity from the raw material supplied by the supply section 10. Furthermore, static electricity may be eliminated using an ionizer together with the humidifying unit 202.

The defibrator 20 performs defibrating processing on the raw material (the roughly crushed pieces) shredded by the rough crush section 12 and generates a defibrated object. In this case, “defibrating” represents disentangling the raw material (an object to be loosed) in which a plurality of fibers are bound, into individual fibers. The defibrator 20 also has a function of separating substances, such as resin particles, ink, toner, and an anti-bleed agent, adhering to the raw material from the fibers.

The object which passed through the defibrator 20 is called “defibrated object”. The “defibrated object” may include particles of a resin (a resin for binding a plurality of fibers) separated from the fibers when the fibers are disentangled; colorant, such as ink and toner; and additives, such as an anti-bleed agent and a paper strengthening agent, in addition to the disentangled fibers of the defibrated object. The shape of the disentangled defibrated object is a string shape or a ribbon shape. The disentangled defibrated object may be provided in a state in which the defibrated object is not intertwined with the other disentangled fibers (an independent state), or may be provided in a state in which the defibrated object is intertwined with the other disentangled defibrated object and hence is in a block state (a state in which what-is-called “lump” is formed).

The defibrator 20 performs defibrating in a dry process. In this case, executing processing such as defibrating not in a liquid but in a gas such as an atmosphere (air) is called dry process. In this embodiment, the defibrator 20 uses an impeller mill. To be specific, the defibrator 20 includes a rotor (not illustrated) that rotates at a high speed, and a liner (not illustrated) located at the outer periphery of the rotor. The roughly crushed pieces roughly crushed by the rough crush section 12 are pinched between the rotor and the liner of the defibrator 0 and loosed. The defibrator 20 generates an airflow due to rotation of the rotor. With the airflow, the defibrator 20 can suck the roughly crushed pieces being the raw material from the pipe 2, and transport the defibrated object to an outlet port 24. The defibrated object is fed from the outlet port 24 to a pipe 3, and is transferred through the pipe 3 to the sorting section 40.

As described above, the defibrated object generated by the defibrator 20 is transported from the defibrator 20 to the sorting section 40 by the airflow generated by the defibrator 20. Furthermore, in this embodiment, the sheet manufacturing apparatus 100 includes a defibrator blower 26 that is an airflow generating device. The airflow generated by the defibrator blower 26 transports the defibrated object to the sorting section 40. The defibrator blower 26 is attached to the pipe 3, sucks the air together with the defibrated object from the defibrator 20, and blows the air to the sorting section 40.

The sorting section 40 has an inlet port 42 into which the defibrated object loosed by the defibrator 20 together with the airflow flows from the pipe 3. The sorting section 40 sorts the defibrated object introduced to the inlet port 42 in accordance with the length of fiber. To be more specific, the sorting section 40 sorts the defibrated object loosed by the defibrator 20 into a defibrated object with a predetermined size or smaller as a first sorted object, and a defibrated object larger than the first sorted object as a second sorted object. The first sorted object includes fibers, particles, or the like. The second sorted object includes, for example, large fibers, non-loosed pieces (roughly crushed pieces which are not sufficiently loosed), and a lump in which defibrated object are aggregated or entangled.

In this embodiment, the sorting section 40 has a drum portion (a sieve portion) 41 and a housing portion (a cover portion) 43 that houses the drum portion 41.

The drum portion 41 is a cylindrical sieve that is rotationally driven by a motor. The drum portion 41 has a net (a filter, a screen) and functions as a sieve. With the mesh of the net, the drum portion 41 sorts the defibrated object to the first sorted object smaller than the size of the apertures (openings) of the mesh of the net, and the second sorted object larger than the apertures of the mesh of the net. The net of the drum portion 41 may use, for example, a wire net, an expanded metal obtained by expanding a metal sheet with cuttings, or a punching metal obtained by forming holes in a metal sheet with a press or the like.

The defibrated object introduced to the inlet port 42 is fed into the drum portion 41 together with the airflow, and the first sorted object falls downward from the mesh of the net of the drum portion 41 by rotation of the drum portion 41. The second sorted object which does not pass through the mesh of the net of the drum portion 41 is sent by the airflow flowing into the drum portion 41 from the inlet port 42, guided to an outlet port 44, and fed to a pipe 8.

The pipe 8 couples the inside of the drum portion 41 and the pipe 2 to each other. The second sorted object sent through the pipe 8 flows through the pipe 2 together with the roughly crushed pieces roughly crushed by the rough crush section 12, and is guided to an inlet port 22 of the defibrator 20. Thus, the second sorted object is returned to the defibrator 20 and subjected to the defibrating processing.

The first sorted object sorted by the drum portion 41 is dispersed into the air through the mesh of the net of the drum portion 41, and descends toward a mesh belt 46 of the first web forming section 45 located below the drum portion 41.

The first web forming section 45 (a separating section) includes the mesh belt 46 (a separating belt), a support roller 47, and a suction portion (a suction mechanism) 48. The mesh belt 46 is an endless-form belt, is supported by three support rollers 47, and is transported in a direction indicated by an arrow in the drawing by motions of the support rollers 47. The mesh belt 46 has a surface that is constituted of a net in which openings with a predetermined size are arrayed. Fine particles having sizes that pass through the mesh of the net and included in the first sorted object descending from the sorting section 40 fall to a position below the mesh belt 46; and fibers with sizes that do not pass through the mesh of the net are deposited on the mesh belt 46 and are transported in the arrow direction together with the mesh belt 46. The fine particles falling from the mesh belt 46 include fine particles that are relatively small and have low density (resin particles, a colorant, an additive, etc.) in the defibrated object, and that are an elimination object not to be used by the sheet manufacturing apparatus 100 for manufacturing a sheet S.

The mesh belt 46 moves at a constant speed V1 during a normal operation of manufacturing a sheet S. In this case, “during a normal operation” represents during an operation excluding during execution of start control and stop control of the sheet manufacturing apparatus 100 (described later). To be more specific, “during a normal operation” represents a period in which the sheet manufacturing apparatus 100 manufactures a sheet S with desirable quality.

The defibrated object after the defibrating processing by the defibrator 20 is sorted into the first sorted object and the second sorted object by the sorting section 40. The second sorted object is returned to the defibrator 20. In addition, the elimination object is eliminated from the first sorted object by the first web forming section 45. The residual after the elimination of the elimination object from the first sorted object is a material suitable for manufacturing a sheet S. The material is deposited on the mesh belt 46 and forms a first web W1.

The suction portion 48 sucks the air from below the mesh belt 46. The suction portion 48 is coupled to a dust collector 27 through a pipe 23. The dust collector 27 is a dust collecting device of filter type or cyclone type, and separates the fine particles from the airflow. A collecting blower 28 (a separating and sucking portion) is disposed downstream of the dust collector 27. The collecting blower 28 sucks the air from the dust collector 27. The air output by the collecting blower 28 passes through a pipe 29 and is output to the outside of the sheet manufacturing apparatus 100.

With this configuration, the collecting blower 28 sucks the air from the suction portion 48 through the dust collector 27. In the suction portion 48, the fine particles which passed through the mesh of the net of the mesh belt 46 are sucked together with the air and are fed to the dust collector 27 through the pipe 23. The dust collector 27 separates the fine particles which passed through the mesh belt 46 from the airflow and stores the fine particles.

Thus, the fibers after the elimination object was eliminated from the first sorted object are deposited on the mesh belt 46 and the first web W1 is formed. Since the collecting blower 28 performs the sucking, the formation of the first web W1 on the mesh belt 46 is promoted and the elimination object is quickly eliminated.

The humidifying unit 204 supplies humidifying air to a space including the drum portion 41. The humidifying air humidifies the first sorted object in the sorting section 40. Thus, the adhesion of the first sorted object to the mesh belt 46 due to static electricity is weakened, and the first sorted object can be more easily peeled off from the mesh belt 46. Furthermore, the adhesion of the first sorted object to the rotary body 49 or the inner wall of the housing portion 43 due to static electricity can be suppressed. The suction portion 48 can efficiently suck the elimination object.

In the sheet manufacturing apparatus 100, the configuration that sorts the defibrated object into the first defibrated object and the second defibrated object and separates the first defibrated object and the second defibrated object from each other is not limited to the sorting section 40 including the drum portion 41. For example, a configuration that classifies, by using a classifier, the defibrated object after the defibrating processing by the defibrator 20 may be employed. The classifier may be, for example, a cyclone classifier, an elbow-jet classifier, or an eddy classifier. By using such a classifier, the sorted object can be sorted into the first sorted object and the second sorted object, and the first sorted object and the second sorted object can be separated from each other. Furthermore, with the above-described classifier, a configuration that separates and eliminates the elimination object including fine particles that are relatively small and have low density (resin particles, a colorant, an additive, etc.) can be provided. For example, the classifier may eliminate fine particles included in the first sorted object from the first sorted object. In this case, the second sorted object may be returned to the defibrator 20, the elimination object may be collected by the dust collector 27, and the first sorted object excluding the elimination object may be fed to a pipe 54.

In the transport path of the mesh belt 46, the humidifying unit 210 supplies the air including a mist to a downstream side of the sorting section 40. The mist which is fine particles of water and generated by the humidifying unit 210 descends toward the first web W1 and supplies moisture to the first web W1. Thus, the quantity of moisture contained in the first web W1 is controlled and attraction of fibers to the mesh belt 46 due to static electricity and so forth can be suppressed.

The sheet manufacturing apparatus 100 includes the rotary body 49 that divides the first web W1 deposited on the mesh belt 46. The first web W1 is peeled off from the mesh belt 46 at a position at which the mesh belt 46 is folded back by the support roller 47, and is divided by the rotary body 49.

The first web W1 is a soft material formed in a web shape because fibers are deposited. The rotary body 49 disentangles the fibers of the first web W1 and hence processes the fibers of the first web W1 so that resin can be easily mixed to the fibers by the mixing section 50 (described later).

The configuration of the rotary body 49 is desirably determined. In this embodiment, the rotary body 49 may have a rotary blade shape having a plate-shaped blade and being rotatable. The rotary body 49 is arranged at a position at which the blade contacts the first web W1 to be peeled off from the mesh belt 46. With the rotation (for example, rotation in a direction indicated by arrow R in the drawing) of the rotary body 49, the blade collides with and subdivides the first web W1 transported while being peeled off from the mesh belt 46, and hence generates subdivided bodies P.

The rotary body 49 is desirably disposed at a position at which the blade of the rotary body 49 does not collide with the mesh belt 46. For example, the distance between the tip end of the blade of the rotary body 49 and the mesh belt 46 can be in a range of from 0.05 mm to 0.5 mm. In this case, the rotary body 49 can efficiently subdivide the first web W1 without giving damage on the mesh belt 46.

The bodies P subdivided by the rotary body 49 descend in a pipe 7, and are transferred (transported) to the mixing section 50 by an airflow flowing in the pipe 7.

In addition, the humidifying unit 206 supplies humidifying air to a space including the rotary body 49. Thus, a phenomenon in which fibers are attracted to the inside of the pipe 7 or the blade of the rotary body 49 due to static electricity can be suppressed. Moreover, since the air with high humidity is supplied through the pipe 7 to the mixing section 50, the influence of static electricity can be suppressed also in the mixing section 50.

The mixing section 50 includes an additive supply portion 52 that supplies an additive including a resin, a pipe 54 that communicates with the pipe 7 and through which the airflow including the subdivided bodies P flows, and a mixing blower 56 (a transfer blower).

The subdivided bodies P are the fibers obtained by eliminating the elimination object from the first sorted object which passed through the sorting section 40 as described above. The mixing section 50 mixes an additive including a resin to the fibers that constitute the subdivided bodies P.

In the mixing section 50, the mixing blower 56 generates an airflow and transports the subdivided bodies P and the additive while mixing the subdivided bodies P and the additive together in the pipe 54. The subdivided bodies P are disentangled in the process of flowing through the inside of the pipe 7 and the pipe 54, and become further fine fibers.

The additive supply portion 52 (a resin housing portion) is coupled to an additive cartridge (not illustrated) that stores an additive, and supplies the additive in the additive cartridge to the pipe 54. The additive cartridge may be detachably attached to the additive supply portion 52. In addition, a configuration that supplements the additive to the additive cartridge may be provided. The additive supply portion 52 temporarily stores an additive formed of fine powder or fine particles in the additive cartridge. The additive supply portion 52 has an output portion 52a (a resin supply portion) that feeds the temporarily stored additive to the pipe 54. The output portion 52a includes a feeder (not illustrated) that feeds the additive stored in the additive supply portion 52 to the pipe 54 and a shutter (not illustrated) that opens and closes a duct that couples the feeder and the pipe 54 to each other. When the shutter is closed, a duct or an opening that couples the output portion 52a and the pipe 54 to each other is closed, and the supply with the additive from the additive supply portion 52 to the pipe 54 is stopped.

When the feeder of the output portion 52a is not operated, the additive is not supplied from the additive supply portion 52 to the pipe 54. When a negative pressure is generated in the pipe 54, the additive may flow to the pipe 54 although the output portion 52a is stopped. By closing the output portion 52a, such a flow of the additive can be reliably blocked.

The additive that is supplied by the additive supply portion 52 includes a resin for binding a plurality of fibers. The resin included in the additive is a thermoplastic resin or a thermosetting resin, and may be, for example, AS resin, ABS resin, polypropylene, polyethylene, polyvinyl chloride, polystyrene, acrylic resin, polyester resin, polyethylene terephthalate, polyphenylene ether, polybutylene terephthalate, nylon, polyamide, polycarbonate, polyacetal, polyphenylene sulfide, or polyetheretherketone. One of these resins may be used or some of these resins may be mixed and used. That is, the additive may contain a single substance or may be a mixture of some substances; or may contain a plurality of types of particles, each type of particles being constituted of a single substance or a plurality of substances. The additive may be fiber form or powder form.

The resin contained in the additive is melted with heat and binds a plurality of fibers together. Thus, in a state in which a resin is mixed with fibers and the resin is not heated to a melting temperature, the fibers are not bound together.

The additive that is supplied by the additive supply portion 52 may include, in addition to the resin that binds fibers together, a coloring agent for coloring fibers, an anti-aggregation agent that suppresses aggregation of fibers or aggregation of resin, and a flame retardant for making fibers etc. flame-resistant, in accordance with the type of a sheet to be manufactured. The additive not including a coloring agent may be colorless, may have a light color by a certain degree that seems to be colorless, or may be white.

With the airflow generated by the mixing blower 56, the subdivided bodies P descending through the pipe 7 and the additive supplied by the additive supply portion 52 are sucked into the pipe 54 and pass through the mixing blower 56. Using the airflow generated by the mixing blower 56 and/or the action of a rotary portion such as a blade of the mixing blower 56, the fibers which constitute the subdivided bodies P and the additive are mixed together. The mixture (the mixture of the first sorted object and the additive) passes through the pipe 54 and is transferred to the deposition section 60.

The mechanism that mixes the first sorted object and the additive together is not particularly limited and may be a configuration that stirs the first sorted object and the additive by using a blade that rotates at a high speed, or may be a configuration that uses rotation of a container like a V-type mixer. Such a mechanism may be disposed in front or in rear of the mixing blower 56.

The deposition section 60 introduces the mixture which passed through the mixing section 50 from an inlet port 62, disentangles the entangled defibrated object (fibers), and causes the disentangled defibrated object to descend while dispersing the defibrated object in the air. Further, when the resin of the additive to be supplied from the additive supply portion 52 is in a fiber form, the deposition section 60 disentangles the entangled resin. Thus, the deposition section 60 can uniformly deposit the mixture in the second web forming section 70.

The deposition section 60 has a drum portion 61 (a drum) and a housing portion (a cover portion) 63 that houses the drum portion 61. The drum portion 61 is a cylindrical sieve that is rotationally driven by a motor. The drum portion 61 has a net (a filter, a screen) and functions as a sieve. With the mesh of the net, the drum portion 61 allows fibers and particles smaller than the apertures (openings) of the mesh of the net to pass therethrough and to descend from the drum portion 61. The configuration of the drum portion 61 is, for example, the same configuration as the configuration of the drum portion 41.

It is to be noted that the “sieve” of the drum portion 61 may not have the function of sorting a specific object. That is, the “sieve” that is used as the drum portion 61 represents being provided with a net. The drum portion 61 may cause the entirety of the mixture introduced to the drum portion 61 to descend.

The second web forming section 70 (a web forming section) is arranged below the drum portion 61. The second web forming section 70 deposits a passing object which passed through the deposition section 60 and forms a second web W2 (a deposit). The second web forming section 70 has, for example, a mesh belt 72 (a mesh body), a roller 74, and a suction mechanism 76.

The mesh belt 72 is an endless-form belt, is supported by a plurality of rollers 74, and is transported in a direction indicated by an arrow in the drawing by motions of the rollers 74. The mesh belt 72 is made of, for example, metal, resin, fabric, or nonwoven fabric. The mesh belt 72 has a surface that is constituted of a net in which openings with a predetermined size are arrayed. Fine particles having sizes that pass through the mesh of the net and included in the fibers and particles descending from the drum portion 61 fall to a position below the mesh belt 72; and fibers with sizes that do not pass through the mesh of the net are deposited on the mesh belt 72 and are transported in the arrow direction together with the mesh belt 72. The mesh belt 72 moves at a constant speed V2 during a normal operation of manufacturing a sheet S. During an operation represents the above-described period.

The mesh of the net of the mesh belt 72 is a fine mesh and may have a size that most fibers and particles descending from the drum portion 61 do not pass through the mesh.

The suction mechanism 76 is provided below the mesh belt 72 (on the side opposite to the deposition section 60 side). The suction mechanism 76 includes a suction blower 77. With the sucking force of the suction blower 77, a downward airflow (an airflow directed from the deposition section 60 toward the mesh belt 72) can be generated at the suction mechanism 76.

The suction mechanism 76 sucks the mixture dispersed in the air by the deposition section 60 onto the mesh belt 72. Thus, the formation of the second web W2 on the mesh belt 72 is promoted and the output speed from the deposition section 60 can be increased. Furthermore, the suction mechanism 76 can form a downflow in a falling path of the mixture, and can prevent the defibrated object and the additive from being entangled with one another during falling.

The suction blower 77 (a deposit sucking portion) may output the air sucked from the suction mechanism 76 to the outside of the sheet manufacturing apparatus 100 through a collecting filter (not illustrated). Alternatively, the air sucked by the suction blower 77 may be fed to the dust collector 27 to collect the elimination object included in the air sucked by the suction mechanism 76.

The humidifying unit 208 supplies humidifying air to a space including the drum portion 61. The humidifying air can humidify the inside of the deposition section 60, suppress adhesion of the fibers and particles to the housing portion 63 due to static electricity, and allow the fibers and particles to quickly descend onto the mesh belt 72. Hence the second web W2 with a desirable shape can be formed.

As described above, since the process involves passing through the deposition section 60 and the second web forming section 70 (a web forming step), a second web W2 which contains much air and is softly expanded is formed. The second web W2 deposited on the mesh belt 72 is transported to the sheet forming section 80.

In the transport path of the mesh belt 72, the humidifying unit 212 supplies the air including a mist to the downstream side of the deposition section 60. Thus, the mist generated by the humidifying unit 212 is supplied to the second web W2 and the quantity of moisture contained in the second web W2 is controlled. Thus, attraction of fibers to the mesh belt 72 due to static electricity and so forth can be suppressed.

The sheet manufacturing apparatus 100 is provided with the transport section 79 that transports the second web W2 on the mesh belt 72 to the sheet forming section 80. The transport section 79 has, for example, a mesh belt 79a, a support roller 79b, and a suction mechanism 79c.

The suction mechanism 79c includes a blower (not illustrated). The sucking force of the blower generates an upward airflow at the mesh belt 79a. The airflow sucks the second web W2. The second web W2 is separated from the mesh belt 72 and is sucked to the mesh belt 79a. The mesh belt 79a moves by rotation of the support roller 79b, and transports the second web W2 to the sheet forming section 80. The moving speed of the mesh belt 72 is, for example, the same as the moving speed of the mesh belt 79a.

In this way, the transport section 79 peels off the second web W2 formed on the mesh belt 72 from the mesh belt 72 and transports the second web W2.

The sheet forming section 80 applies heat and pressure to the second web W2 deposited on the mesh belt 72 and transported by the transport section 79, to form a sheet S. The sheet forming section 80 applies heat to the fibers of the defibrated object and the additive included in the second web W2 to bind a plurality of fibers in the mixture together via the additive (resin).

The sheet forming section 80 includes a pressing unit 82 that presses the second web W2 and a heating unit 84 that heats the second web W2 pressed by the pressing unit 82. The pressing unit 82 and the heating unit 84 constitute a forming-section roller unit.

The pressing unit 82 is constituted of a pressing roller pair 85 that pinches and presses the second web W2 with a predetermined nip pressure. When the second web W2 is pressed, the thickness of the second web W2 is decreased and the density thereof is increased.

The pressing roller pair 85 is rotated by a driving force of a motor (not illustrated) and transports the second web W2 whose density was increased by the pressure, toward the heating unit 84.

The heating unit 84 may use, for example, a heating roller (a heater roller), a thermal press forming machine, a hot plate, a warm-air blower, an infrared heater, or a flash fixing device. In this embodiment, the heating unit 84 is constituted of a heating roller pair 86. The heating roller pair 86 is heated to a previously set temperature by a heater that is disposed inside or outside the heating roller pair 86. The heating roller pair 86 pinches the second web W2 pressed by the pressing roller pair 85 and applies heat to the second web W2 to form a sheet S.

In this way, the second web W2 formed by the deposition section 60 is pressed and heated by the sheet forming section 80 and becomes a sheet S. The heating roller pair 86 transports the sheet S toward the cutting section 90.

The cutting section 90 (a cutter section) cuts the sheet S formed by the sheet forming section 80. In this embodiment, the cutting section 90 has a first cutting portion 92 that cuts the sheet S in a direction intersecting with the transport direction of the sheet S, and a second cutting portion 94 that cuts the sheet S in a direction parallel to the transport direction. The second cutting portion 94 cuts, for example, a sheet S which passed through the first cutting portion 92.

Thus, a single sheet S with a predetermined size is formed. The single cut sheet S is output to an output section 96. The output section 96 includes a tray or a stacker on which the sheet S with the predetermined size is placed.

In the above-described configuration, the humidifying units 202, 204, 206, and 208 may be constituted of a single vaporizing type humidifier. In this case, the humidifying air generated by the single humidifier may be supplied to the rough crush section 12, the housing portion 43, the pipe 7, and the housing portion 63 in a split manner. The above-described configuration can be easily provided by disposing ducts (not illustrate) for supplying the humidifying air in a split manner. Alternatively, the humidifying units 202, 204, 206, and 208 may be constituted of two or three vaporizing type humidifiers.

In the above-described configuration, the humidifying units 210 and 212 may be constituted of a single ultrasonic type humidifier or two ultrasonic type humidifiers. For example, the air including a mist generated by the single humidifier may be supplied to the humidifying units 210 and 212 in a split manner.

In addition, the blowers included in the above-described sheet manufacturing apparatus 100 are not limited to the defibrator blower 26, the collecting blower 28, the mixing blower 56, the suction blower 77, and the blower of the suction mechanism 79c. For example, a blower that assists each of the above-described blowers may be provided at a duct.

In addition, in the above-described configuration, the rough crush section 12 roughly crushes the raw material first, and a sheet S is manufactured from the roughly crushed raw material. However, for example, a sheet S may be manufactured by using fibers as a raw material.

For example, fibers equivalent to the defibrated object after the defibrating processing by the defibrator 20 may be input as a raw material to the drum portion 41. Alternatively, fibers equivalent to the first sorted object separated from the defibrated object may be input as a raw material to the pipe 54. In these cases, a sheet S can be manufactured by supplying fibers obtained by processing used paper, pulp, or the like, to the sheet manufacturing apparatus 100.

Next, an eliminating unit serving as an eliminating section is described in detail.

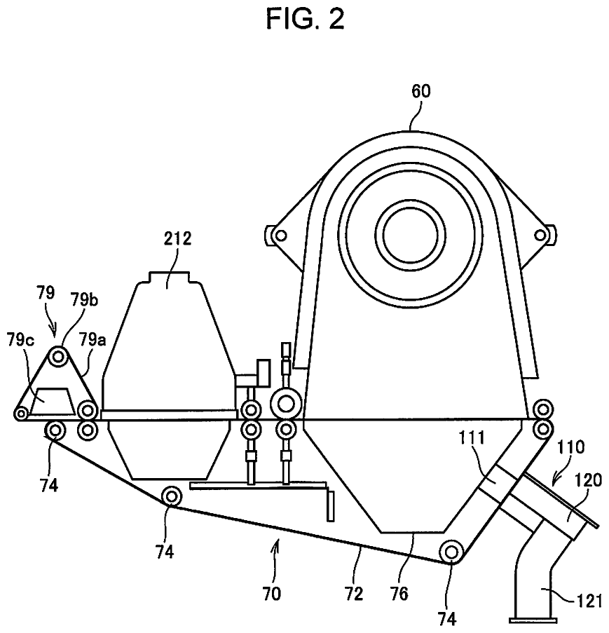

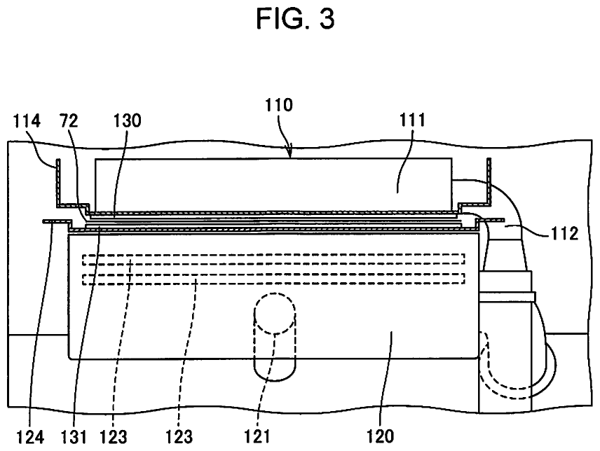

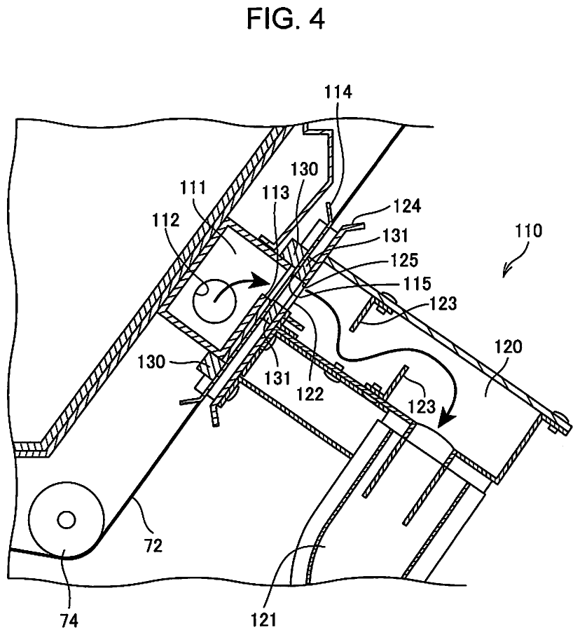

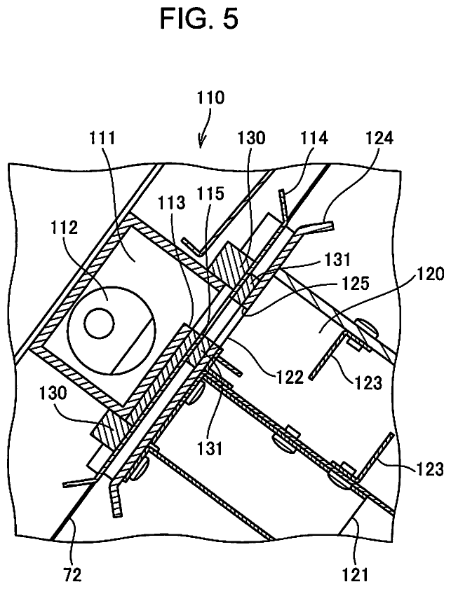

FIG. 2 is a configuration diagram of a deposition section and a transport section. FIG. 3 is a plan view of an eliminating unit. FIG. 4 is a cross-sectional view of the eliminating unit. FIG. 5 is an enlarged view of the eliminating unit.

As illustrated in FIG. 2, in this embodiment, an eliminating unit 110 is disposed at the mesh belt 72, at a position located upstream of the deposition section 60. The eliminating unit 110 includes an air sending chamber 111 arranged on the back surface side of the mesh belt 72. The air sending chamber 111 is formed in an elongated box shape extending in a width direction of the mesh belt 72. An air sending portion 112 that introduces an airflow to the air sending chamber 111 is coupled to one end portion of the air sending chamber 111. The air sending chamber 111 has an outlet port 113 to face the back surface of the mesh belt 72. The airflow from the air sending portion 112 is output toward the back surface side of the mesh belt 72 from the outlet port 113.

The eliminating unit 110 includes a suction chamber 120 arranged on the deposition surface side of the mesh belt 72. The suction chamber 120 has substantially the same width dimension as that of the air sending chamber 111. A suction portion 121 is coupled to a lower surface of the suction chamber 120, at a substantially center portion in a width direction. The suction portion 121 sucks the air from the deposition surface side of the mesh belt 72. The suction chamber 120 has a suction opening 122 formed to face the deposition surface of the mesh melt 72. The suction opening 122 is formed at a position corresponding to the outlet port 113 of the air sending chamber 111.

A plurality of (in this embodiment, two) partition plates 123 serving as wall portions are provided in the suction chamber 120. The partition plates 123 extend in a direction intersecting with a direction in which the airflow flows, and are alternately arranged at positions shifted from each other on facing surfaces (an upper surface and a lower surface) of the suction chamber 120. With the partition plates 123, the airflow sucked from the suction opening 122 meanders in the suction chamber 120, and the airflow spreads in the width direction of the suction chamber 120.

By providing the partition plates 123, the partition plates 123 serve as the resistance to the airflow and can make the airflow flowing into the suction chamber 120 uniform.

An air-sending-side guide member 114 and a suction-side guide member 124 that guide the mesh belt 72 are respectively provided near the air sending chamber 111 and near the suction chamber 120. The air-sending-side guide member 114 and the suction-side guide member 124 are arranged to face each other with the mesh belt 72 interposed therebetween, and have guide surfaces (facing surfaces) that are respectively arranged to be substantially flush with the outlet port 113 of the air sending chamber 111 and the suction opening 122 of the suction chamber 120. In addition, the facing surfaces of the air-sending-side guide member 114 and the suction-side guide member 124 respectively have openings 115 and 125 that are substantially aligned with the outlet port 113 and the suction opening 122.

As illustrated in FIG. 5, a first seal member 130 that contacts the back surface of the mesh belt 72 is provided at the air-sending-side guide member 114. In addition, a second seal member 131 that contacts the deposition surface of the mesh belt 72 is provided at the suction-side guide member 124. The first seal member 130 and the second seal member 131 are constituted of, for example, a fiber material such as moquette, and an elastic material that supports the moquette; and are provided such that the moquette is pressed against the guide members 124 and 114 facing each other with the mesh belt 72 interposed therebetween. Accordingly, sealing is provided between the mesh belt 72 and the periphery of the outlet port 113 of the air sending chamber 111, and between the mesh belt 72 and the periphery of the suction opening 122 of the suction chamber 120.

Alternatively, only one of the first seal member 130 and the second seal member 131 may be provided. For example, only the second seal member 131 near the suction chamber 120 may be provided, and the second seal member 131 may provide pressing such that the mesh belt 72 contacts the air-sending-side guide member 114. In this case, the outlet port 113 and the suction opening 122 desirably have substantially the same sizes and are desirably provided at substantially the same positions so as to face each other with the mesh belt 72 interposed therebetween. With the second seal member 131, the periphery of the outlet port 113 and the periphery of the suction opening 122 can be sealed with respect to the mesh belt 72.

In this way, since the first seal member 130 and the second seal member 131 provide sealing between the air sending chamber 111 and the mesh belt 72, and between the suction chamber 120 and the mesh belt 72, the humidity environment in the vicinity of the suction mechanism is not changed.

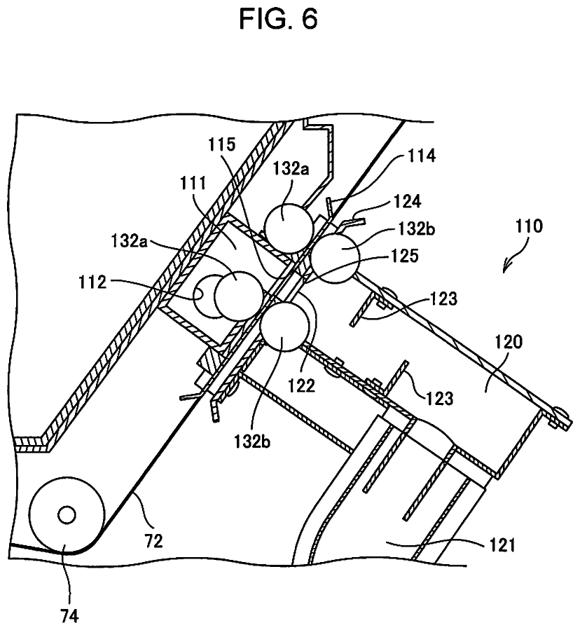

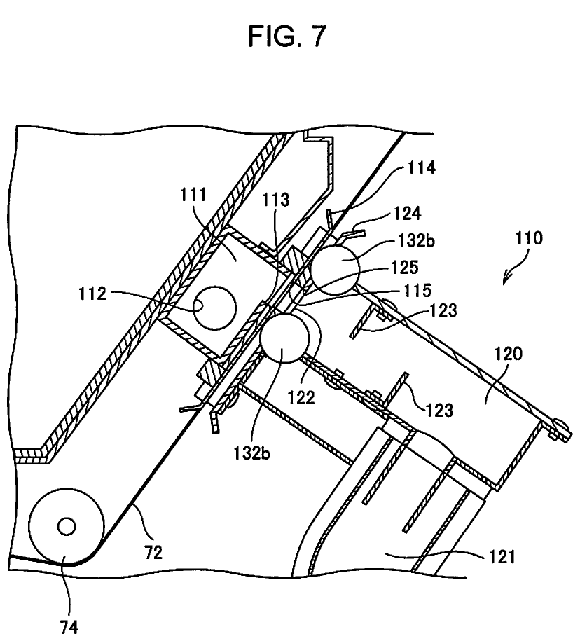

FIG. 6 is a cross-sectional view illustrating another example of sealing. FIG. 7 is a cross-sectional view illustrating still another example of sealing.

In the above-described embodiment, the example is provided in which the first seal member 130 and the second seal member 131 are constituted of the fiber material; however, the invention is not limited thereto. For example, as illustrated in FIG. 6, the first seal member 130 may be constituted of rotatable rollers 132a located at both end portions of the outlet port 113 in the transport direction of the mesh belt 72. The second seal member 131 may be constituted of rotatable rollers 132b located at both end portions of the suction opening 122 in the transport direction of the mesh belt 72.

Since the first seal member 130 and the second seal member 131 are constituted as described above, sealing is provided while the rollers 132a and 132b contact the mesh belt 72 while rotating on the mesh belt 72. A load on the mesh belt 72 can be decreased.

Alternatively, as illustrated in FIG. 7, the first seal member 130 may be omitted, and only the second seal member 131 constituted of the rollers 132b may be provided. In this case, the rollers 132b are provided to be pressed against the air-sending-side guide member 114 that faces the rollers 132b with the mesh belt 72 interposed therebetween. Even when the rollers 132b are provided on only one side of the mesh belt 72, the load on the mesh belt 72 can be decreased and sealing of the air sending chamber 111 and the suction chamber 120 with respect to the mesh belt 72 can be provided.

As illustrated in FIG. 1, a waste powder collecting device 140 is provided. The waste powder collecting device 140 collects the mixture which passed through the mesh of the mesh belt 79a when the second web W2 is separated from the mesh belt 72 and is sucked to the mesh belt 79a by the suction mechanism 79c of the transport section 79. The waste powder collecting device 140 includes a blower 141 and collects the mixture. The airflow generated by the blower 141 is fed to the air sending portion 112 through an air pipe 142. In this way, the air humidified via the suction mechanism 79c that sucks the second web W2 humidified by the humidifying unit 212 is fed to the air sending portion 112 by the blower 141.

In addition, a second waste powder collecting device 143 is provided. The second waste powder collecting device 143 is coupled, through an air pipe 145, to the suction portion 121 of the suction chamber 120 of the eliminating unit 110. The second waste powder collecting device 143 includes a blower 144.

In this way, by driving the blower 141 of the waste powder collecting device 140 and the blower 144 of the second waste powder collecting device 143, the airflow that flows from the air sending portion 112, to the air sending chamber 111, the suction chamber 120, and the suction portion 121 in that order can be generated. Accordingly, the airflow from the back surface side toward the deposition surface side of the mesh belt 72 can be generated.

In this case, since the humidified air can be fed to the air sending portion 112 by using the air from the waste powder collecting device 140, the mesh belt 72 can be prevented from being dried and electrically charged.

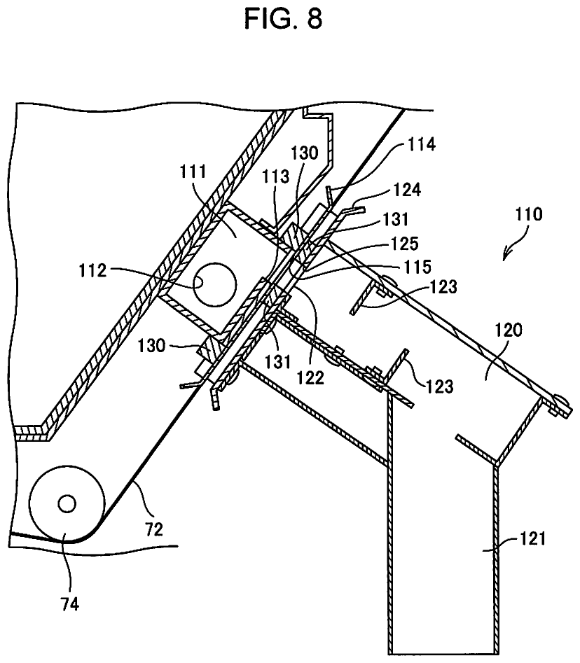

FIG. 8 is a cross-sectional view illustrating another example of the eliminating unit.

FIG. 8 illustrates an example in which the suction portion 121 of the suction chamber 120 is coupled in the vertical direction. Since the suction portion 121 is coupled in this way, when the mixture eliminated from the mesh belt 72 is fed to the second waste powder collecting device 143, the mixture can fall using the gravity and can be smoothly transported.

Next, an operation of the eliminating unit 110 of this embodiment is described.

The blower 141 of the waste powder collecting device 140 is operated first and hence the airflow from the blower 141 is fed from the air sending portion 112 to the air sending chamber 111 through the air pipe 142. In addition, by operating the blower 144 of the second waste powder collecting device 143, the blower 144 sucks the air of the suction chamber 120.

Accordingly, the airflow flowing from the air sending portion 112, to the air sending chamber 111, the outlet port 113, the suction opening 122, the suction chamber 120, and the suction portion 121 in that order can be generated. At this time, since the suction chamber 120 is provided with the partition plates 123, the airflow flowing from the outlet port 113 of the air sending chamber 111 into the suction chamber 120 can be uniform in the width direction of the mesh belt 72.

When the mesh belt 72 is operated in this state, the airflow fed to the suction chamber 120 is blown to the back surface side of the mesh belt 72 from the outlet port 113. The airflow blown to the back surface side of the mesh belt 72 eliminates the mixture adhering to the deposition surface side of the mesh belt 72. The eliminated mixture and the airflow which passed via the mesh belt 72 are fed to the suction chamber 120 and fed to the second waste powder collecting device 143 via the suction portion 121.

By driving the blower 141 of the waste powder collecting device 140 and the blower 144 of the second waste powder collecting device 143 and generating the airflow from the back surface side toward the deposition surface side of the mesh belt 72 in this way, the mixture remaining on the mesh belt 72 can be reliably eliminated.

The mixture is desirably constantly eliminated from the mesh belt 72 during a normal operation of the sheet manufacturing apparatus 100, or more specifically, during an operation of the deposition section 60 and the second web forming section 70 (during formation of the second web W2).

As an elimination mode of the mixture, the mixture may be eliminated when the second web W2 is not formed. When the mixture is eliminated as the elimination mode, the air quantities of the blowers 141 and 144 of the waste powder collecting device 140 and the second waste powder collecting device 143 are increased, and hence the mixture can be more efficiently eliminated. In addition, since the second web W2 is not formed in the elimination mode, the mixture remaining on the mesh belt 72 may be eliminated while the mesh belt 72 is intermittently operated.

In the above-described embodiment, the example has been described in which the eliminating unit 110 is disposed at the mesh belt 72, at the position located upstream of the deposition section 60. However, for example, the eliminating unit 110 may be disposed near the transport section 79. In this case, the mixture can be eliminated from the mesh belt 72 immediately after the second web W2 is peeled off by the transport section 79, and hence the mixture remaining on the mesh belt 72 can be prevented from being scattered.

As described above, according to this embodiment, a second web forming section 70 (a web forming section) that sucks and deposits a mixture including a defibrated object and a resin on a mesh belt 72 (a mesh body) and that forms a second web W2 (a web) is provided. A sheet forming section 80 that forms a sheet S from the second web W2 and an eliminating unit 110 (an eliminating section) that eliminates, by using an airflow, the mixture remaining on the mesh belt 72 are provided.

Accordingly, the eliminating unit 110 can eliminate the mixture remaining on the mesh belt 72 by using the airflow. Consequently, the surface state of the mesh belt 72 can be kept uniform and the durability of the mesh belt 72 can be increased. In addition, since the remaining mixture is not present on a deposition surface side of the mesh belt 72, the mixture can fall on the surface of the mesh belt 72 and the second web W2 can be uniformly formed. Thus, the quality of a sheet S can be stable.

Also, according to this embodiment, the airflow is an airflow directed from a back surface side of a deposition surface of the mesh belt 72 on which the mixture is deposited toward a deposition surface side of the mesh belt 72.

Accordingly, since the eliminating unit 110 sends the airflow directed from the back surface side of the mesh belt 72 toward the deposition surface side of the mesh belt 72, the mixture remaining on the deposition surface side of the mesh belt 72 can be eliminated.

Also, according to this embodiment, the eliminating unit 110 includes an air sending portion 112 that blows an airflow on the mesh belt 72 from the back surface side of the mesh belt 72.

Accordingly, since the eliminating unit 110 sends the airflow from the air sending portion 112 of the eliminating unit 110 toward the back surface side of the mesh belt 72, the mixture remaining on the deposition surface side of the mesh belt 72 can be eliminated.

Also, according to this embodiment, the eliminating unit 110 includes an air sending chamber 111 located on the back surface side of the mesh belt 72 and having an outlet port 113 through which an airflow from the air sending portion 112 is output; and a first seal member 130 that provides sealing between a periphery of the outlet port 113 of the air sending chamber 111 and the mesh belt 72.

Accordingly, since the first seal member 130 provides the sealing between the periphery of the outlet port 113 of the air sending chamber 111 and the mesh belt 72, a change in the humidity environment in the vicinity of the eliminating section 110 can be suppressed.

Also, according to this embodiment, the eliminating unit 110 includes a suction portion 121 that sucks air from the deposition surface side of the mesh belt 72.

Accordingly, since the eliminating unit 110 sucks the air from the deposition surface side of the eliminating unit 110, the mixture remaining on the deposition surface side of the mesh belt 72 can be eliminated.

Also, according to this embodiment, the eliminating unit 110 includes a suction chamber 120 located on the deposition surface side of the mesh belt 72, communicating with the suction portion 121, and having a suction opening 122; and a second seal member 131 that provides sealing between a periphery of the suction opening 122 of the suction chamber 120 and the mesh body.

Accordingly, since the second seal member 131 provides the sealing between the periphery of the suction opening 122 of the suction chamber 120 and the mesh belt 72, a change in the humidity environment in the vicinity of the eliminating unit 110 can be suppressed.

Also, according to this embodiment, the eliminating unit 110 includes an air sending chamber 111 located on the back surface side of the mesh belt 72 and having an outlet port 113 through which an airflow is output to the mesh belt 72; a suction chamber 120 located on the deposition surface side of the mesh belt 72 and having a suction opening 122 which faces the outlet port 113 and through which air from the outlet port 113 is sucked; an air-sending-side guide member 114 that is located on the back surface side of the mesh belt 72 and that guides the mesh belt 72; and a second seal member 131 that is located between the suction chamber 120 and the mesh belt 72, that presses the mesh belt 72 against the air-sending-side guide member 114, and that provides sealing between a periphery of the suction opening 122 and the mesh belt 72 and between a periphery of the outlet port 113 and the mesh belt 72.

Accordingly, the second seal member 131 provided between the suction chamber 120 and the mesh belt 72 has a function of the sealing between the periphery of the outlet port 113 of the air sending chamber 111 and the mesh belt 72, and between the periphery of the suction opening 122 of the suction chamber 120 and the mesh belt 72. Thus, the structure can be simplified.

Also, according to this embodiment, the suction chamber 120 has at least one partition plate 123 (a wall portion) provided in a direction intersecting with a flow direction of an airflow.

Accordingly, since the partition plate 123 is provided, an airflow flowing in the suction chamber 120 can be uniform.

Also, according to this embodiment, humidified air is supplied to the eliminating section 110 and the eliminating section 110 eliminates the mixture by using the humidified air.

Accordingly, since the humidified air is used, electrical charge due to dryness of the mesh belt 72 can be suppressed.

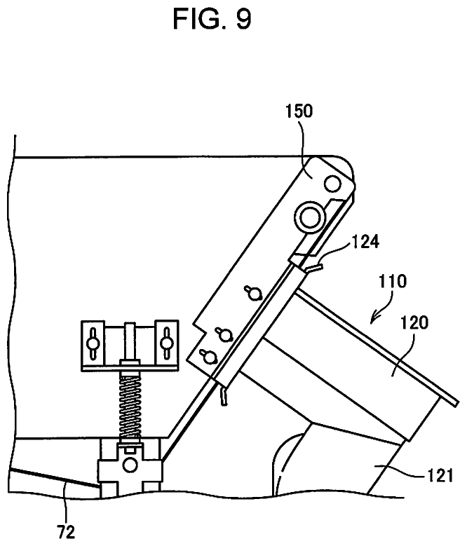

FIG. 9 is a cross-sectional view illustrating a modification of the eliminating unit.

As illustrated in FIG. 9, support frames 150 that support the eliminating unit 110 are provided on both sides of the eliminating unit 110. Upper end portions of the support frames 150 are swingably supported. In this modification, the upper end portions of the support frames 150 are swingable around the axis of the roller 74 of the mesh belt 72.

The length of the mesh belt 72 may change due to variations in dimension at manufacturing or extension through use over time. When the length of the mesh belt 72 changes in this way, the mesh belt 72 supported by the roller 74 may change in inclination at the position at which the eliminating unit 110 is disposed.

In this embodiment, since the support frames 150 are swingable around the axis of the roller 74, the position of the eliminating unit 110 can be adjusted in accordance with the inclination of the mesh belt 72.

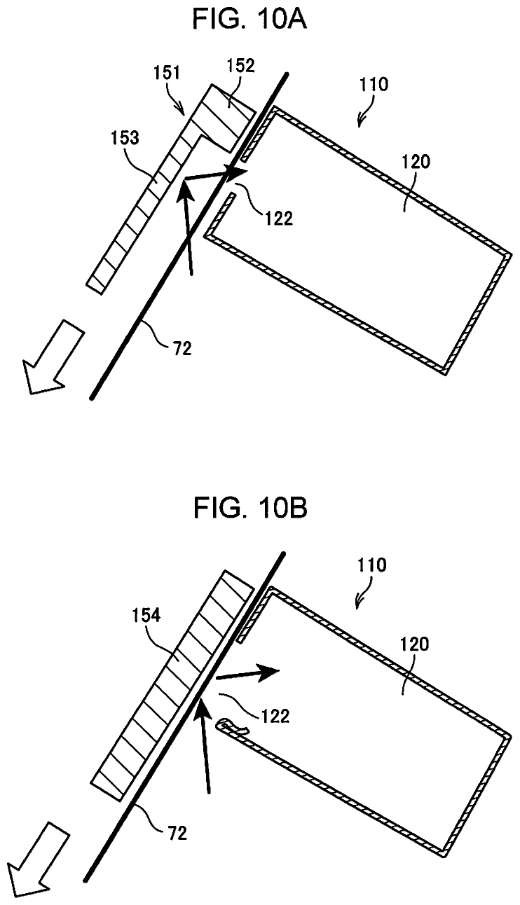

FIG. 10A and FIG. 10B are explanatory views each illustrating an example when an airflow flows from the deposition surface side of the mesh belt.

FIG. 10A illustrates an example in which a lead member 151 is arranged on the back surface side of the mesh belt 72. The lead member 151 includes a base portion 152 arranged near an opening end portion of the suction opening 122 of the suction chamber 120, and a plate member 153 extending from the base portion 152 and arranged at a predetermined distance from the back surface of the mesh belt 72.

An air sending portion (not illustrated) that sends an airflow from the deposition surface side of the mesh belt 72 toward the plate member 153 is disposed beside the suction chamber 120.

As indicated by arrows in FIG. 10A, the airflow from the air sending portion passes through the mesh belt 72, is reflected by the plate member 153 and the base portion 152, and is sucked into the suction opening 122 of the suction chamber 120.

FIG. 10B illustrates an example in which a reflecting member 154 is arranged on the back surface side of the mesh belt 72. The reflecting member 154 is formed in a plate shape, and is disposed near the back surface of the mesh belt 72 along the mesh belt 72.

An air sending portion (not illustrated) that sends an airflow from the deposition surface side of the mesh belt 72 toward the reflecting member 154 is disposed beside the suction chamber 120.

As indicated by arrows in FIG. 10B, the airflow from the air sending portion passes through the mesh belt 72, is reflected by the reflecting member 154, and is sucked into the suction opening 122 of the suction chamber 120.

In this way, even with the configuration that sends the air from the deposition surface side of the mesh belt 72, the airflow can flow from the back surface side toward the deposition surface side of the mesh belt 72, and the mixture remaining on the mesh belt 72 can be eliminated.

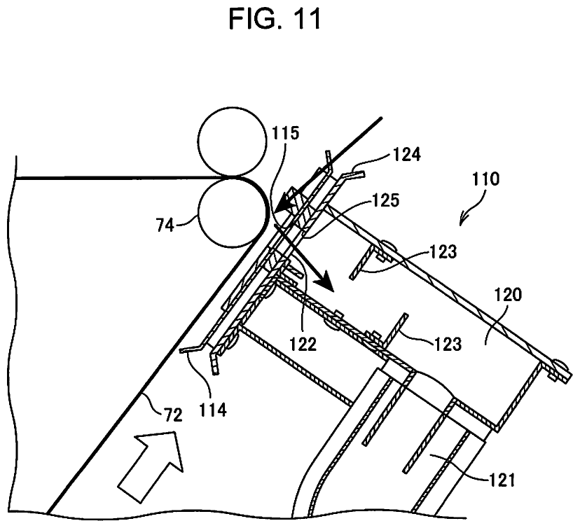

FIG. 11 is an explanatory view illustrating another example when an airflow flows from the deposition surface side of the mesh belt.

As illustrated in FIG. 11, the suction opening 122 of the suction chamber 120 is arranged to face the roller 74 of the mesh belt 72. As indicated by arrows in FIG. 11, an air sending portion (not illustrated) sends an airflow from a direction opposite to the transport direction of the mesh belt 72.

In this case, by sending the airflow toward the roller 74, the roller 74 is used as a reflecting member.

With this configuration, as indicated by arrows in FIG. 11, the airflow from the air sending portion passes through the mesh belt 72, is reflected by the roller 74, and is sucked into the suction opening 122 of the suction chamber 120.

Accordingly, even with the configuration that sends the air from the deposition surface side of the mesh belt 72, the airflow can flow from the back surface side toward the deposition surface side of the mesh belt 72, and the mixture remaining on the mesh belt 72 can be eliminated.

The embodiment of the invention has been described above; however, the invention is not limited to the embodiment and can be modified in various ways as required.

For example, in the above-described embodiment, the example has been described in which the invention is applied to the sheet manufacturing apparatus in a dry process. The invention is not limited thereto, and the invention can be applied to, for example, a sheet manufacturing apparatus in a wet process.

In the above-described embodiment, the airflow flows by the air sending from the air sending chamber 111 and the suction from the suction chamber 120. However, the airflow may flow by one of the air sending and the suction. Even with this configuration, an airflow flowing from the back surface side toward the deposition surface side of the mesh belt 72 is generated, and the mixture remaining on the mesh belt 72 can be eliminated by the airflow.

In the above-described embodiment, the eliminating unit 110 uses an airflow. However, a configuration that uses an eliminating member such as a scraper or a brush that contacts the mesh belt 72 and eliminates the mixture may be employed, or a configuration that vibrates the mesh belt 72 and eliminates the mixture may be employed. The eliminating unit 110 may be constituted by combining any of airflow type, contact type, and vibration type.

The eliminating unit 110 of the above-described embodiment may be applied as an eliminating unit that eliminates a defibrated object remaining on the mesh belt 46 of the first web forming section 45.

### REFERENCE SIGNS LIST

10 supply section
20 defibrator
40 sorting section
50 mixing section
60 deposition section
70 second web forming section
72 mesh belt
74 roller
79 transport section
80 sheet forming section
100 sheet manufacturing apparatus
110 eliminating unit
111 air sending chamber
112 air sending portion
113 outlet port
114 air-sending-side guide member
120 suction chamber
121 suction portion
122 suction opening
123 partition plate
124 suction-side guide member
130 first seal member
131 second seal member
132 roller
S sheet
W1 first web
W2 second web

1. A sheet manufacturing apparatus comprising:
a web forming section that deposits a mixture including a defibrated object and a resin on a mesh body and that forms a web;
a transport section that transports the web from the mesh body; and
an eliminating section that eliminates, by using an airflow, the mixture remaining on the mesh body after the web is transported by the transport section, wherein
the eliminating section generates the airflow.

2. The sheet manufacturing apparatus according to claim 1, wherein the airflow generated from the eliminating section is an airflow directed from a back surface side of a deposition surface of the mesh body on which the mixture is deposited toward a deposition surface side of the mesh body.

3. The sheet manufacturing apparatus according to claim 2, wherein the eliminating section includes an air sending portion that blows an airflow on the mesh body from the back surface side of the mesh body.

4. The sheet manufacturing apparatus according to claim 3, further comprising an air sending chamber located on the back surface side of the mesh body and having an outlet port through which an airflow from the air sending portion is output; and a first seal member that provides sealing between a periphery of the outlet port of the air sending chamber and the mesh body.

5. The sheet manufacturing apparatus according to claim 2, wherein the eliminating section includes a suction portion that sucks air from the deposition surface side of the mesh body.

6. The sheet manufacturing apparatus according to claim 5, further comprising a suction chamber located on the deposition surface side of the mesh body, communicating with the suction portion, and having a suction opening; and a second seal member that provides sealing between a periphery of the suction opening of the suction chamber and the mesh body.

7. The sheet manufacturing apparatus according to claim 2, wherein
the eliminating section includes
an air sending chamber located on the back surface side of the mesh body and having an outlet port through which an airflow is output to the mesh body,
a suction chamber located on the deposition surface side of the mesh body and having a suction opening which faces the outlet port and through which air from the outlet port is sucked,
a guide portion that is located on the back surface side of the mesh body and that guides the mesh body, and
a seal member that is located between the suction chamber and the mesh body, that presses the mesh body against the guide portion, and that provides sealing between a periphery of the suction opening and the mesh body and between a periphery of the outlet port and the mesh body.

8. The sheet manufacturing apparatus according to claim 6, wherein the suction chamber has at least one wall portion provided in a direction intersecting with a flow direction of an airflow.

9. The sheet manufacturing apparatus according to claim 1, wherein humidified air is supplied to the eliminating section and the eliminating section eliminates the mixture by using the humidified air.
